(19) United States
(12) Patent Application Publication
(10) Pub. No.: US 2009/0033769 A1
(43) Pub. Date: Feb. 5, 2009

(54) IMAGE SHOOTING APPARATUS

(75) Inventors: Shiro Nagaoka, Ome-shi (JP); Kuniaki Takahashi, Fukaya-shi (JP); Tatsuhiko Ikehata, Ome-shi (JP); Kei Tashiro, Ome-Shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/129,603

(22) Filed: May 29, 2008

(30) Foreign Application Priority Data
Jul. 31, 2007 (JP) 2007-199397

(51) Int. Cl. H04N 5/76

(52) U.S. Cl. 348/231.5; 348/231.2; 386/95; 348/E05.1; 386/E05.001

(57) ABSTRACT

According to one embodiment an image shooting apparatus comprises shooting mechanism for shooting image information, generating means for generating a moving image stream data file and a moving image information data file formed of information associated with the moving image stream data file as separate files for one title in the image information shot by the shooting means, and first recording means for recording the moving image stream data file and the moving image information data file generated by the generating means as separate files.

### CROSS-REFERENCE TO RELATED APPLICATIONS

This application is based upon and claims the benefit of priority from Japanese Patent Application No. 2007-199397, filed Jul. 31, 2007, the entire contents of which are incorporated herein by reference.

### BACKGROUND

1. Field

One embodiment of the present invention relates to an image shooting apparatus having a moving image playback function.

2. Description of the Related Art

In recent years, digital equipment such as multi-function digital still cameras and digital video cameras has become remarkably widespread. In such digital video cameras, shot images are put in moving image stream data files, and the moving image stream data files and moving image information data files associated with the moving image stream data files are stored in directories of the file system.

Jpn. Pat. Appln. KOKAI Pub. No. 2004-350042 discloses a structure in which moving image information data files including various metadata concerning moving image data files and sound data files are stored in one directory, and thereby a desired data file is easily recognized and selected from many files.

The invention has been made to solve the above problem. The object of the invention is to provide an image shooting apparatus having a file structure in which a moving image stream data file is easily recognized.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external view of a shooting apparatus according to a first embodiment of the invention.

FIG. 2 is another external view of the shooting apparatus according to the first embodiment of the invention.

FIG. 3 is a block diagram illustrating a structure of the shooting apparatus according to the first embodiment of the invention.

FIG. 4 is a diagram illustrating a file structure according to the first embodiment of the invention.

FIG. 5 is a diagram illustrating a file structure according to the first embodiment of the invention.

FIG. 6 is a diagram illustrating a file structure according to the first embodiment of the invention.

FIG. 7 is a diagram illustrating a file structure according to the first embodiment of the invention.

FIG. 8 is a diagram illustrating a file structure according to the first embodiment of the invention.

FIG. 9 is a diagram illustrating a structure of a moving image information data file according to the first embodiment of the invention.

FIG. 10 is a diagram illustrating the structure of the moving image information data file according to the first embodiment of the invention.

FIG. 11 is a flowchart illustrating recognition of a moving image stream data file according to the first embodiment of the invention.

FIG. 12 is a flowchart illustrating recognition of a moving image stream data file according to the first embodiment of the invention.

FIG. 13 is a flowchart illustrating recognition of a moving image stream data file according to the first embodiment of the invention.

### DETAILED DESCRIPTION

Various embodiments according to the invention will be described hereinafter with reference to the accompanying drawings. In general, according to one embodiment of the invention, an image shooting apparatus comprises shooting means for shooting image information, generating means for generating a moving image stream data file and a moving image information data file formed of information associated with the moving image stream data file as separate files for one title in the image information shot by the shooting means, and first recording means for recording the moving image stream data file and the moving image information data file generated by the generating means as separate files.

An embodiment of the invention is explained below with reference to drawings.

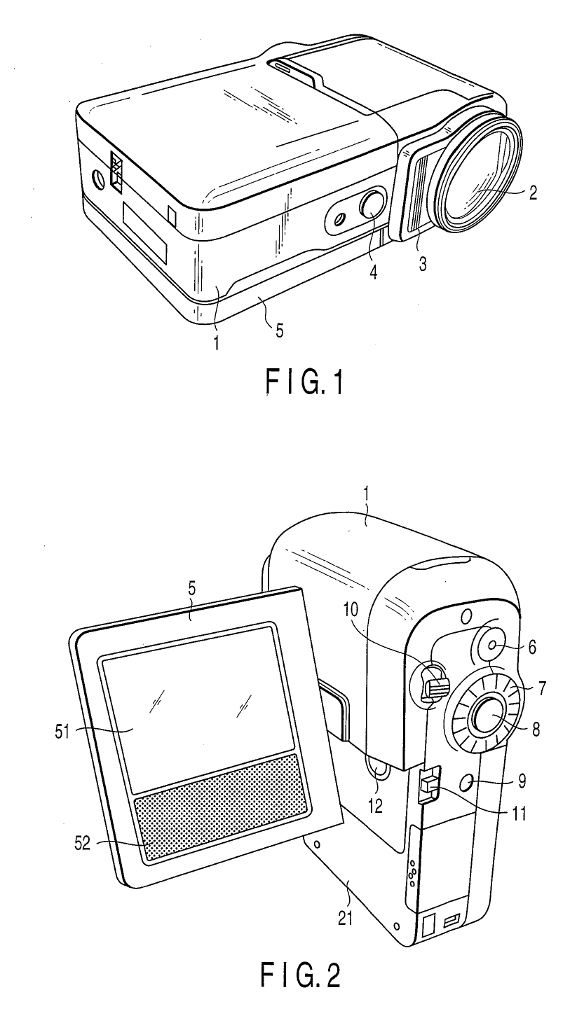

FIGS. 1 and 2 are diagrams illustrating an example of an image shooting apparatus according to the invention. FIG. 1 is a diagram illustrating a state where a display section is housed in a housing section provided in the main body forming the image shooting apparatus. FIG. 2 is a diagram illustrating a state where images displayed on the display section is viewable.

As illustrated in FIGS. 1 and 2, the image shooting apparatus has the main body 1. The main body 1 comprises a lens 2, a flash 3, a still image recording button 4, a display section 5, a moving image recording button 6, a jog dial 7, a cross key 8, a menu button 9, a zoom bar 10, a mode lever 11, and a power button 12, etc.

Further, the main body 1 has a housing section 21, and the display section 5 can be housed in the housing section 21. The display section 5 is configured to be movable and can be taken out of the housing section 21, and a display screen thereof can be adjusted to a desired angle. The display section 5 has an LCD (liquid crystal display) 51 and a speaker 52.

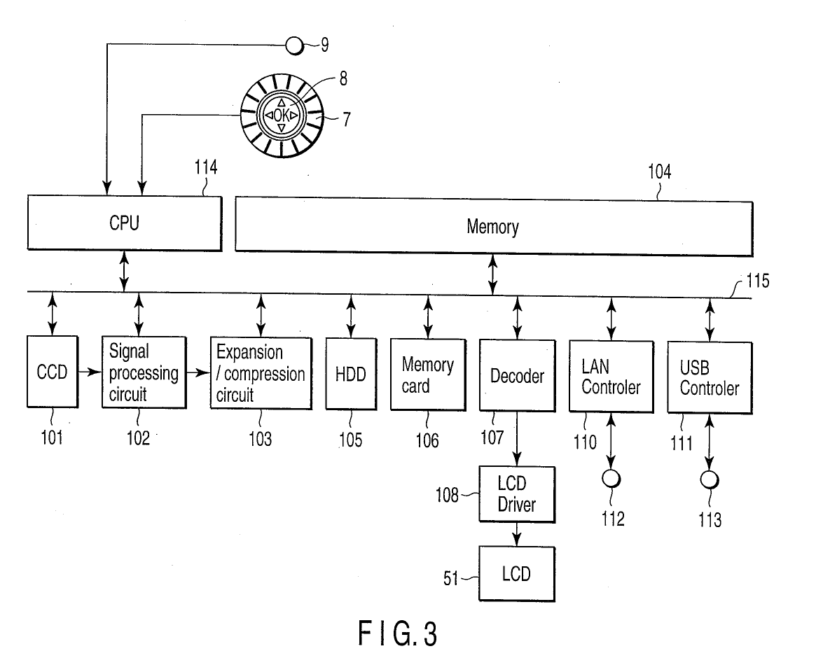

FIG. 3 is a block diagram illustrating a schematic structure of the image shooting apparatus explained with reference to FIGS. 1 and 2.

As illustrated in FIG. 3, the image shooting apparatus comprises a CCD 101, a signal processing circuit 102, an expansion/compression circuit (JPEG/MPEG/H.264) 103, a memory 104, an HDD 105, a memory card 106, a decoder 107, an LCD driver 108, an LCD 51, a LAN controller 110, a USB controller 111, a LAN terminal 112, a USB terminal 113, and a CPU 114, etc. These components are connected through a bus 115.

In response to operation of the still image recording button 4, the CCD 101 converts light (a still image) obtained through the lens 2 into an electric image. In response to operation of the moving image recording button 6, the CCD 101 also converts light (moving images) obtained through the lens 2 into an electric signal. The signal processing circuit 102 converts the electric signal output from the CCD 101 into a digital signal. The expansion/compression circuit 103 encodes the digital signal of the still image into an image signal compliant with JPEG. The expansion/compression circuit 103 also encodes the digital signal of the moving image into an image signal compliant with MPEG or H.264. The HDD 105 stores the image signal provided through the memory 104. The detachable memory card 106 also stores the image signal provided through the memory 104. The decoder 107 decodes the image signal provided through the memory 104. The LCD driver 108 controls driving of the LCD 51 based on the decoded image signal, and outputs an image signal on the liquid crystal display.

When a recorded image is played back, the decoder 107 decodes an image signal provided from the HDD 105 or the memory card 106 through the expansion/compression circuit 103 and the memory 104. The LCD driver 108 controls driving of the LCD 51 based on the decoded image signal, and outputs an image signal onto the LCD 51.

When moving images are played back, trick playback such as reverse playback, high-speed playback, high-speed reverse playback, frame advance, and frame rewind can be easily achieved in addition to normal playback. Further, moving images are read from random-access media such as the HDD 105 and the memory card 106, unlike a tape, and thus a search for a desired image can be easily performed.

When an image recorded on the HDD 105 or the memory card 106 is transferred to an external apparatus (such as a personal computer) or an image is received from an external apparatus, images are transmitted or received through the USB terminal 113 via the USB controller 111. Further, an encoded image can be directly transmitted to or received from an image recording and playback apparatus, such as a DVD recorder, without an external apparatus such as a personal computer. Furthermore, playback of moving images is started by operation of the cross key 8 by the user, and playback speed of the moving images being played back is finely changed by user's rotating the jog dial 7 when the moving images are being played back.

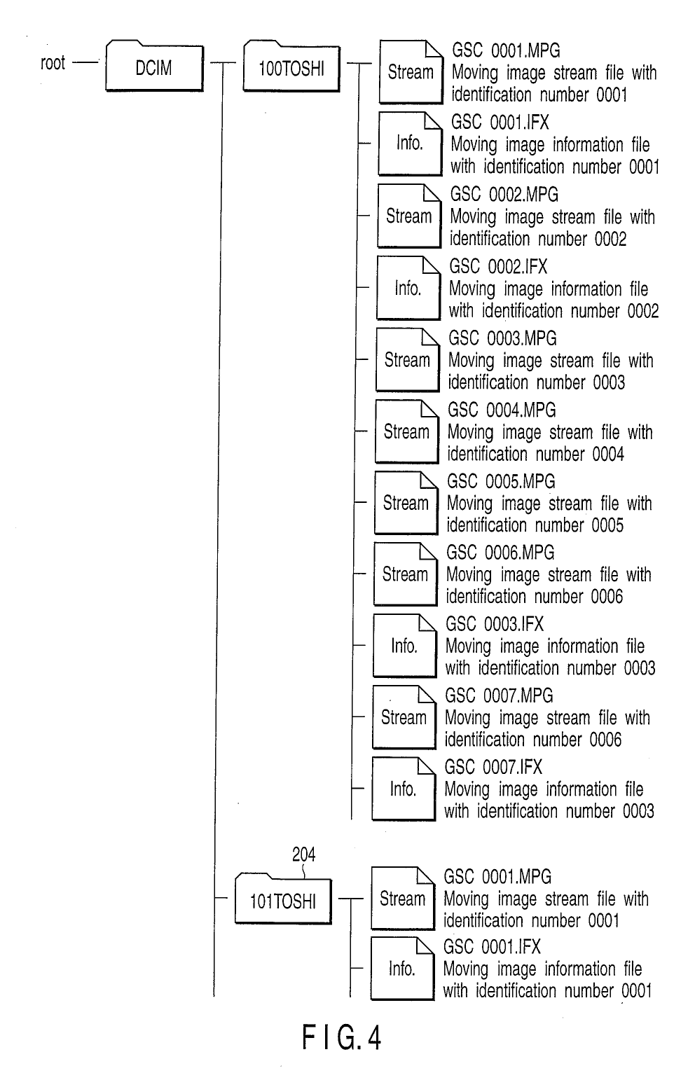

Next, a file directory structure in the invention is explained with reference to FIG. 4. When the user shoot images by the image shooting apparatus, the CPU 114 generates folders and files in the HDD 105 (or the memory card 106) as illustrated in FIG. 4. A DCIM folder is generated under the root directory, and a 100TOSHI folder and a 101TOSHI folder are generated as folders under the DCIM folder.

Further, shot image information items are recorded as files in the folders 100TOSHI and 101TOSHI. Stream data items (with an extension MPG) are stored as moving image stream data files, and Info data items (with an extension IFX) are stored as moving image information data files. Each moving image stream data file includes a moving image stream data item. Each moving image information data file only includes associated information relating to the moving image stream data included in the corresponding moving stream data file. The structure of the moving image information data files is detailed below.

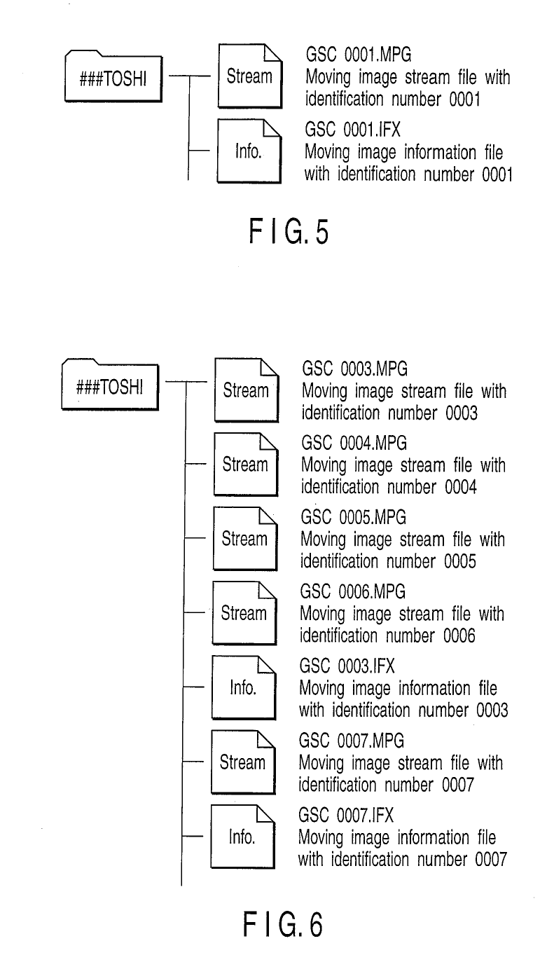

FIG. 5 is a diagram illustrating a part of the file directory structure illustrated in FIG. 5. FIG. 5 illustrates an example in which one moving image stream data file is generated for a moving image information item (hereinafter referred to as “one title”) obtained by one recording, which lasts until the end of recording since the user pushes the moving image recording button 6. In the folder “###TOSHI”, generated are a moving image stream data file (with the file name “GSC_{—}0001.MPG”) which includes the identification number 0001 in its file name and a moving image information data file (with the file name “GSC_{—}0001.IFX”) which includes the identification number 0001 in its file name. The CPU 114 processes a moving image stream data file and a moving image information data file that include the same identification number in their file names, as a pair. A number from 100 to 999 is put into the part “###” in the folder name “###TOSHI”.

FIG. 6 is a diagram illustrating another part of the file directory structure illustrated in FIG. 4, which is different from the part illustrated in FIG. 5. FIG. 6 illustrates an example in which a plurality of moving image stream data files are generated, by dividing image information of one title shot by the user into a plurality of moving image items (hereinafter referred to as divided moving images). When the CPU 114 generates a plurality of moving image stream data files for image information of one title, the CPU 114 assigns sequential identification numbers to the moving image stream data files. Since the size of one moving image stream file is set to a predetermined value, when recording of moving images is performed for a long time, the CPU 114 generates a plurality of moving image stream data files for image information of one title.

The folder “###TOSHI” stores four moving image stream data files, that is, a moving image stream data file (with the file name “GSC_{—}0003.MPG”) including identification number 0003 in its file name, a moving image stream data file (with the file name “GSC_{—}0004.MPG”) including identification number 0004 in its file name, a moving image stream data file (with the file name “GSC_{—}0005.MPG”) including identification number 0005 in its file name, and a moving image stream data file (with the file name “GSC_{—}0006.MPG”) including identification number 0006 in its file name, as the group of moving stream image files generated for the image information of one title. Further, the CPU 114 generates only one moving image information data file corresponding to the group of the moving image stream data files. In this example, a moving image information data file (with the file name “GSC_{—}0003.IFX) including identification number 0003 in its file name. Specifically, the moving image information data file is generated with a file name which includes the smallest identification number (0003 in this example) in the identification numbers of the moving image stream data files.

Further, the folder “###TOSHI” also includes a moving image stream data file (with the file name “GSC_{—}0007.MPG”) including identification number 0007 in its file name, and a moving image information data file (with the file name “GSC_{—}0007.IFX”) including the identification number 0007 in its file name.

The CPU 114 performs the following association processing to process the moving image information data file including identification number 0003 in its file name and the group of moving stream data files generated for image information for one title, that is, from the moving image stream data file including identification number 0003 in its file name to the moving image stream data file including identification number 0006 in its file name, as a pair.

The smallest identification number (0003 in this example) in the moving image stream data file group is set in the file name of the moving image information data file. The smallest identification number in the moving image stream data file group indicates that the moving image stream data file is the first moving image stream data file, from which recording of image information for one title was started.

Therefore, by recognizing the file name of a moving image information data file, the CPU 114 can identify a moving image stream data file corresponding to the moving image information data file among a plurality of moving image stream data files existing in the folder. Further, when a plurality of moving image stream data files are generated for image information of one title, the CPU 114 identify the first moving image stream data file in divided moving images of image information of one title. The CPU 114 associates a moving image stream data file (with the file name “GSC_{—}0003.MPG”) including identification number 0003 in its file name with a moving image information data file (with the file name “GSC_{—}0003.IFX”) including identification number 0003 in its file name, and stores them in the memory 104.

Further, the CPU 114 identifies the last moving image stream data file in divided moving images as follows. The CPU 114 searches for a file including identification number 0004, which follows (is larger by 1 than) the identification number 0003, in its file name. Since a moving image stream data file (with the file name “GSC_{—}0004.MPG”) is the only file which includes identification number 0004 in its file name, the CPU 114 determines that the moving image stream data file (with the file name “GSC_{—}0004.MPG”) including identification number 0004 in its file name and the moving image stream data file (with the file name “GSC_{—}0003.MPG”) including identification number 0003 in its file name belong to the same title.

Next, the CPU 114 searches for a file including identification number 0005, which follows (is larger by 1 than) the identification number 0004, in its file name. Since a moving image stream data file (with the file name “GSC_{—}0005.MPG”) is the only file which includes identification number 0005 in its file name, the CPU 114 determines that the moving image stream data file (with the file name “GSC_{—}0005.MPG”) including identification number 0005 in its file name, the moving image stream data file (with the file name “GSC_{—}0003.MPG”) including identification number 0003 in its file name, and the moving image stream data file (with the file name “GSC_{—}0004.MPG”) including identification number 0004 in its file name belong to the same title.

In the same manner, the CPU 114 searches for a file including identification number 0006, which follows (is larger by 1 than) the identification number 0005, in its file name. Since a moving image stream data file (with the file name “GSC_{—}0006.MPG”) is the only file which includes identification number 0006 in its file name, the CPU 114 determines that the moving image stream data file (with the file name “GSC_{—}0006.MPG”) including identification number 0006 in its file name, the moving image stream data file (with the file name “GSC_{—}0003.MPG”) including identification number 0003 in its file name, the moving image stream data file (with the file name “GSC_{—}0004.MPG”) including identification number 0004 in its file name, and the moving image stream data file (with the file name “GSC_{—}0005.MPG”) including identification number 0005 in its file name belong to the same title.

Further, the CPU 114 searches for a file including identification number 0007, which follows (is larger by 1 than) the identification number 0006, in its file name. The folder “###TOSHI” includes a moving image stream data file (with the file name “GSC_{—}0007.MPG”) and a moving image information data file (with the file name “GSC_{—}0007.IFX”), which include the identification number 0007 in their file names. Since the files have the same identification number 0007, the CPU 114 determines that the files should be processed as a pair. Therefore, the CPU 114 determines that the moving image stream data file including identification number 0007 in its file name is recorded for one title which is different from the title of the moving image stream data files including the identification numbers 0003 to 0006 in their file names (that is, the file 0007 is not recorded by the same continuous recording as the former files). Thus, the CPU 114 identifies the moving image stream data file (with the file name “GSC_{—}0003.MPG”) including identification number 0003 in its file name (the first moving image stream data file) to the moving image stream data file (with the file name “GSC_{—}0006.MPG”) including identification number 0006 in its file name (the last moving image stream data file), as moving image stream data files belonging to the same title.

Then, the CPU 114 regards the moving image stream data file (with the file name “GSC_{—}0003.MPG”) including identification number 0003 in its file name to the moving image stream data file (with the file name “GSC_{—}0006.MPG”) including identification number 0006 in its file name as one title, associates them with the moving image information data file (with the file name “GSC_{—}0003.IFX”) including identification number 0003 in its file name, and stores them in the memory 104.

As described above, the CPU 114 performs processing with the following conditions.

(1) Although there are cases where a plurality of divided moving image stream data files are generated for image information of one title, only one moving image information data file is generated for the image information of the title, without exception.

(2) The divided moving image stream data files generated for image information of one title always have sequential identification numbers, and the identification numbers are included in their respective file names.

(3) The file name of the moving image information data file includes the smallest identification number among the identification numbers included in the file names of the divided moving image stream data files.

Thereby, the CPU 114 determines the range of divided moving image stream data files for one title, on the basis of file names.

Then, by the above processing, the CPU 114 determines which moving image stream data file (divided moving image stream data files) and which moving image information data file correspond as one title, and stores information indicating correspondence of the files in the memory 104. Thereby, when playback of specific image information is selected, the CPU 114 can perform playback of a correct moving image stream data file. Further, since no moving image information data files are attached to moving image stream data files, moving image stream data files serve as data having high general versatility. Specifically, the apparatus is configured to deal with moving image stream data files for one title and a corresponding moving image information data file as a pair, each file can be easily utilized. Therefore, when moving image stream data is played back on a personal computer connected to the image shooting apparatus, the possibility of success in playback is increased regardless of the manufacturer of the personal computer.

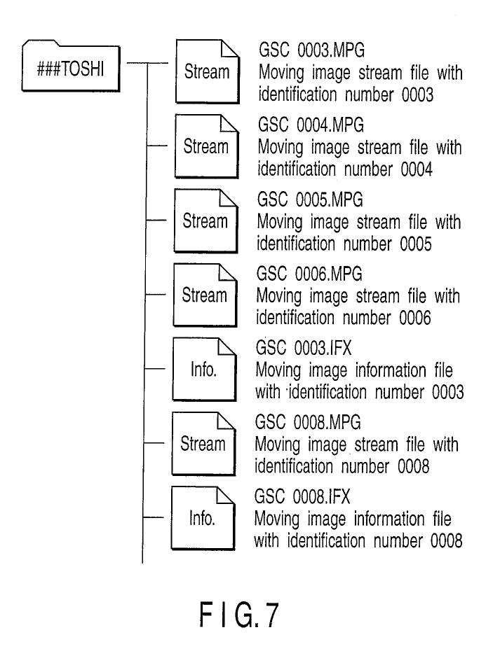

FIG. 7 is a diagram illustrating a part of the file directory structure of FIG. 4 in the case where other image information is shot. When the user records new image information by pushing the moving image recording button 6, the CPU 114 generates a moving image stream data file with the file name “GSC_{—}0008.MPG”) including identification number 0008 in its file name, and a moving image information data file (with the file name “GSC_{—}0008.IFX”) including identification number 0008 in its file name in a folder “###TOSHI”. The file structure illustrated in FIG. 7 illustrates the case where thereafter the user erases the moving image stream data file (with the file name “GSC_{—}0007.MPG”) including identification number 0007 in its file name, and a moving image information data file (with the file name “GSC_{—}0007.IFX”) including identification number 0007 in its file name by predetermined operation.

The CPU 114 can associate a plurality of divided moving image stream data files generated for one title with a corresponding moving image information data file, in accordance with the above conditions (1) to (3). Specifically, based on the file name of the moving image information data file including identification number 0003 in its file name, if there is a moving image stream data file including identification number 0003 in its file name among a plurality of moving image stream data files, the CPU 114 can determine that the moving image stream data file is the first moving image stream data file of the title. Based on the above conditions (1) to (3), the CPU 114 determines that the moving image stream data file (with the file name “GSC_{—}0003.MPG”) including identification number 0003 in its file name, the moving image stream data file (with the file name “GSC_{—}0004.MPG”) including identification number 0004 in its file name, the moving image stream data file (with the file name “GSC_{—}0005.MPG”) including identification number 0005 in its file name, and the moving image stream data file (with the file name “GSC_{—}0006.MPG”) including identification number 0006 in its file name belong to the same title.

Further, the CPU 114 searches for a file including identification number 0007, which follows and is larger by one than identification number 0006, in its file name. Since the folder “###TOSHI” does not include a moving image stream data file (with the file name “GSC_{—}0007.MPG”) and a moving image information data file (with the file name “GSC_{—}0007.IFX”) which include identification number 0007 in their file names, the CPU 114 searches for a file including identification number 0008, which follows and is larger by one than identification number 0007, in its file name. The folder “###TOSHI” includes a moving image stream data file (with the file name “GSC_{—}0008.MPG”) and a moving image information data file (with the file name “GSC_{—}0008.IFX”) which include identification number 0008 in their file names. Since the found files have the same identification number, the CPU 114 determines that they should be processed as a pair. Therefore, the CPU 114 determines that the moving image stream data file including identification number 0008 in its file name was recorded for one title which is different from the title of the moving image stream data files with identification numbers 0003 to 0006 in their file names (that is, the file was not recorded by the same continuous recording as the former files). Therefore, the CPU 114 identifies the moving image stream data file (with the file name “GSC_{—}0003.MPG”) including identification number 0003 in its file name (the first moving image stream data file) to the moving image stream data file (with the file name “GSC_{—}0006.MPG”) including identification number 0006 in its file name (the last moving image stream data file), as moving image stream data files belonging to the same title.

Then, the CPU 114 regards the moving image stream data file (with the file name “GSC_{—}0003.MPG”) including identification number 0003 in its file name to the moving image stream data file (with the file name “GSC_{—}0006.MPG”) including identification number 0006 in its file name as one title, associates them with the moving image information data file (with the file name “GSC_{—}0003.IFX”) including identification number 0003 in its file name, and stores them in the memory 104.

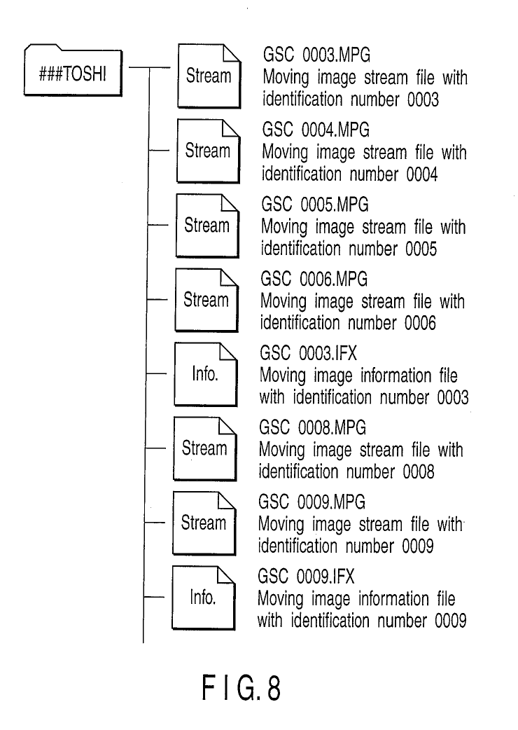

FIG. 8 is a diagram illustrating the file directory structure illustrated in FIG. 4 in the case where further other image information is recorded. In the state where the files illustrated in FIG. 4 are recorded on the HDD 105, the user pushes the moving image recording button 6 and records new image information. The CPU 114 generates a moving image stream file (with the file name “GSC_{—}0009.MPG”) including identification number 0009 in its file name and a moving image information data file (with the file name “GSC_{—}0009.IFX”) including identification number 0009 in its file name in the folder “###TOSHI”.

FIG. 8 illustrates the state where the user connects the image shooting apparatus in the above state to a personal computer or the like, and erases the moving image information data file (with the file name “GSC_{—}0008.IFX”) including identification number 0008 in its file name on the personal computer.

In this case, as explained above, the CPU 114 associates a plurality of divided moving image stream data files for one title with a corresponding moving image information data file as follows. The CPU 114 determines that the moving image stream data file (with the file name “GSC_{—}0003.MPG”) including identification number 0003 in its file name, the moving image stream data file (with the file name “GSC_{—}0004.MPG”) including identification number 0004 in its file name, the moving image stream data file (with the file name “GSC_{—}0005.MPG”) including identification number 0005 in its file name, and the moving image stream data file (with the file name “GSC_{—}0006.MPG”) including identification number 0006 in its file name belong to the same title.

Further, the CPU 114 searches for a file including identification number 0007, which follows and is larger by one than identification number 0006, in its file name. Since the folder “###TOSHI” does not include a moving image stream data file (with the file name “GSC_{—}0007.MPG”) or a moving image information data file (with the file name “GSC_{—}0007.IFX”) which include identification number 0007 in their file names, the CPU 114 searches for a file including identification number 0008, which follows and is larger by one than identification number 0007, in its file name. The folder “###TOSHI” includes a moving image stream data file (with the file name “GSC_{—}0008.MPG”) which includes identification number 0008 in its file name, and thus the CPU 114 determines that the moving image stream data files including identification numbers 0003, 0004, 0005, 0006 and 0008 in their file names belong to the same title.

Further, the CPU 114 searches for a file including identification number 0009, which follows and is larger by one than identification number 0008, in its file name. The folder “###TOSHI” includes a moving image stream data file (with the file name “GSC_{—}0009.MPG”) and a moving image information data file (with the file name “GSC_{—}0009.IFX”) which include identification number 0009 in their file names. Since they have the same identification number, the CPU 114 determines that the found files should be processed as a pair. Therefore, the CPU 114 determines that the moving image stream data file including identification number 0009 in its file name was recorded for one title which is different from the title of the moving image stream data files with identification numbers 0003, 0004, 0005, 0006, and 0008 in their file names (that is, the file is not recorded by the same continuous recording as the former files). Specifically, the CPU 114 determines that the five moving image stream data files GSC_{—}0003.MPG, GSC_{—}0004.MPG, GSC_{—}0005.MPG, GSC_{—}0006.MPG, and GSC_{—}0008.MPG belong to the same title. However, actually, the four moving image stream data files GSC_{—}0003.MPG, GSC_{—}0004.MPG, GSC_{—}0005.MPG, and GSC_{—}0006.MPG belong to the same title, and the moving image stream data file with the file name “GSC_{—}0008.MPG” belong to a different title. This means that the CPU 114 recognizes inappropriate moving image stream data files in error.

Therefore, to prevent such an error, the CPU 114 performs the following processing (4), when obtaining moving image stream data files for one title in a folder including a plurality of moving image stream data files for a plurality of titles.

(4) To check the range of moving image stream data files corresponding to the moving image information data file, which is described in the header of the moving image information data file.

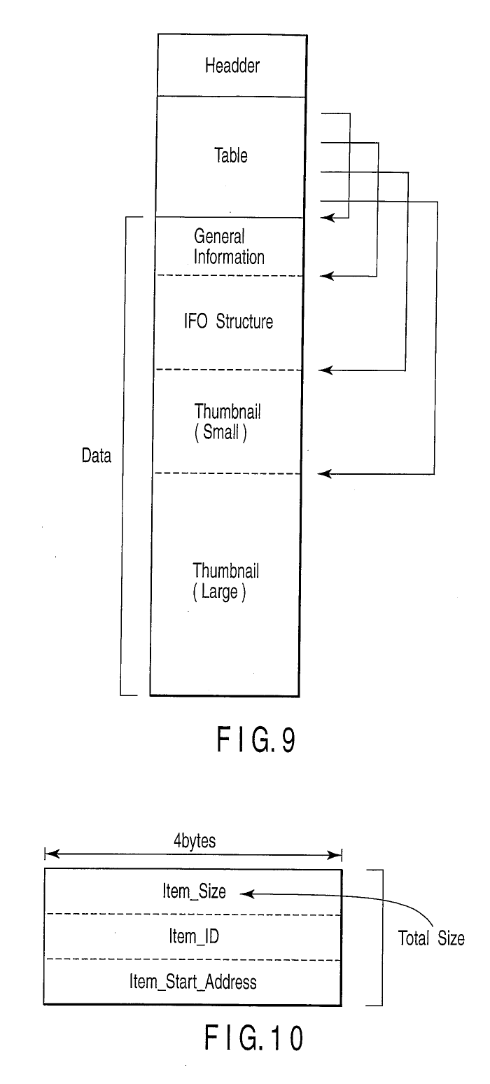

Next, the structure of the moving image information data file is explained with reference to FIGS. 9 and 10.

FIG. 9 illustrates the structure of a moving image information data file. The moving image information data file is formed of a header, a table, and data comprising general information, an IFO structure, a thumbnail (small) and a thumbnail (large). Even when a plurality of divided moving image stream data files are generated for image information of one title, one moving image information data file is generated for the data files. The header records range information to determine which moving image stream data files correspond to the moving image information data file as one title. The table has the block structure illustrated in FIG. 10. The components “item size”, “item ID”, and “item start address” in the table store respective data information items of the moving image information data file. For example, when the ID of the IFO structure is put into the item ID, the size of the IDO structure is read in the item size, and information of the IFO structure data is read in the item start address.

The general information records metadata items such as the date and time, the temperature, and the location at which the image information corresponding to the moving image information data file is shot by the image shooting apparatus, and information such as edit date and time and the number of edits in the case where the image information has been edited by the image shooting apparatus. If the moving image information data file and moving image stream data files corresponding to it are captured by a personal computer, the personal computer can manage the files, by using metadata included in the general information as file names thereof. Therefore, moving image stream data can be easily managed on a personal computer when the moving image information data file has metadata.

The IFO structure records information concerning the position of data, such as GOP information of image frames forming moving images and chapter information, to appropriately play back moving image stream data when the data is played back at a midpoint or advanced frame by frame. The image shooting apparatus records image information compressed by MPEG as moving image stream data. Therefore, the image shooting apparatus forms moving images by combining image frames formed of I frames, P frames, and B frames. Therefore, when moving image stream data is played back at a midpoint or advanced frame by frame, moving images are smoothly played back by recognizing locations of the image frames.

The thumbnail (small) and the thumbnail (large) represent the first still image in image information of one title, in different sizes. The thumbnail (small) and the thumbnail (large) are generated by the CPU 114 when image information is shot, and recorded in the moving image information data file. Therefore, when thumbnails (small) of the moving image information data files recorded on the HDD 105 are displayed in list form on the LCD 51, since each moving image information data file records a thumbnail (small) in advance, the CPU 114 can immediately read the thumbnails from the HDD 105 and display them on the LCD 51. Further, when the user wishes to see an enlarged view of a specific thumbnail (small) in the list of the small thumbnails, the CPU 114 can display the thumbnail (large) by only reading the thumbnail (large) from the moving image information data file by selection of the thumbnail (small). Therefore, the user does not feel a time lag in display of thumbnails.

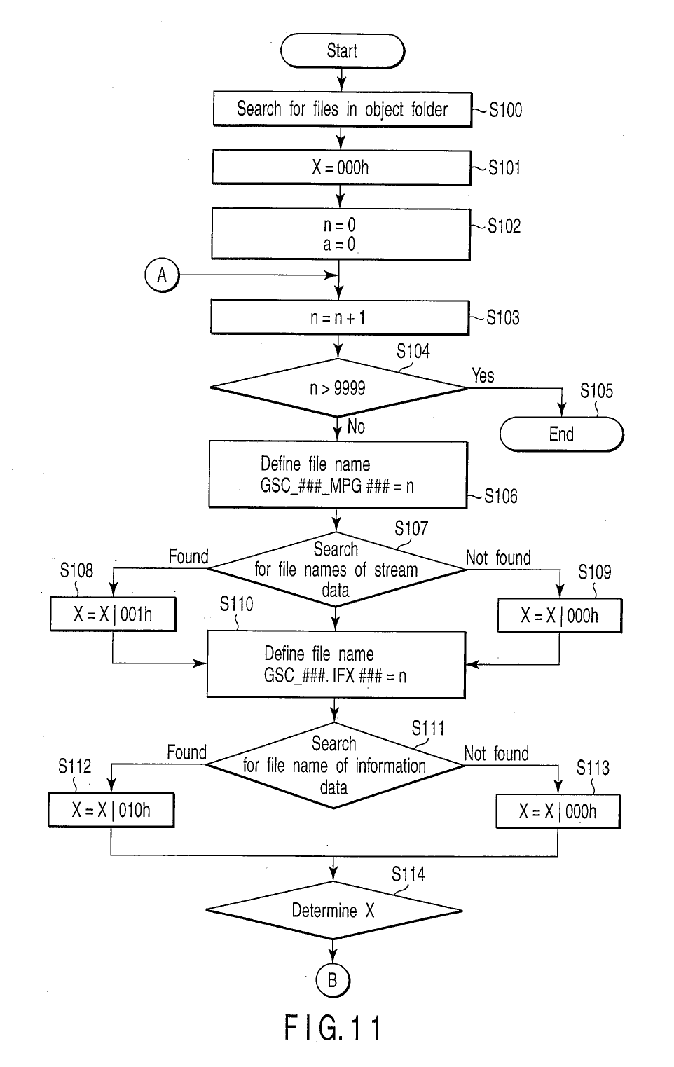

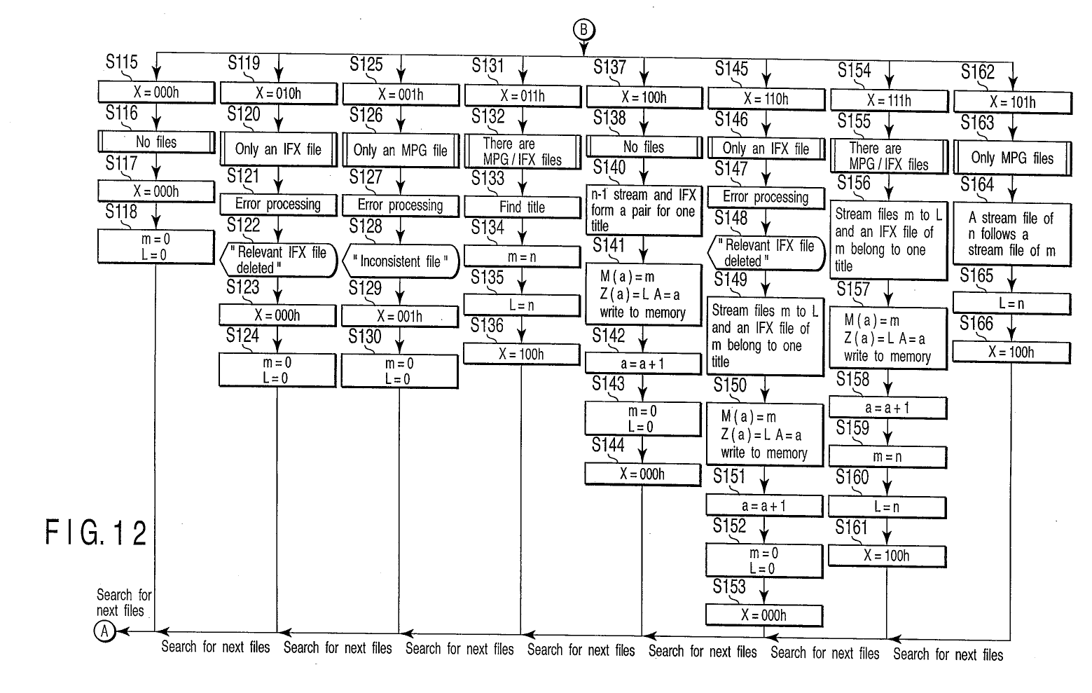

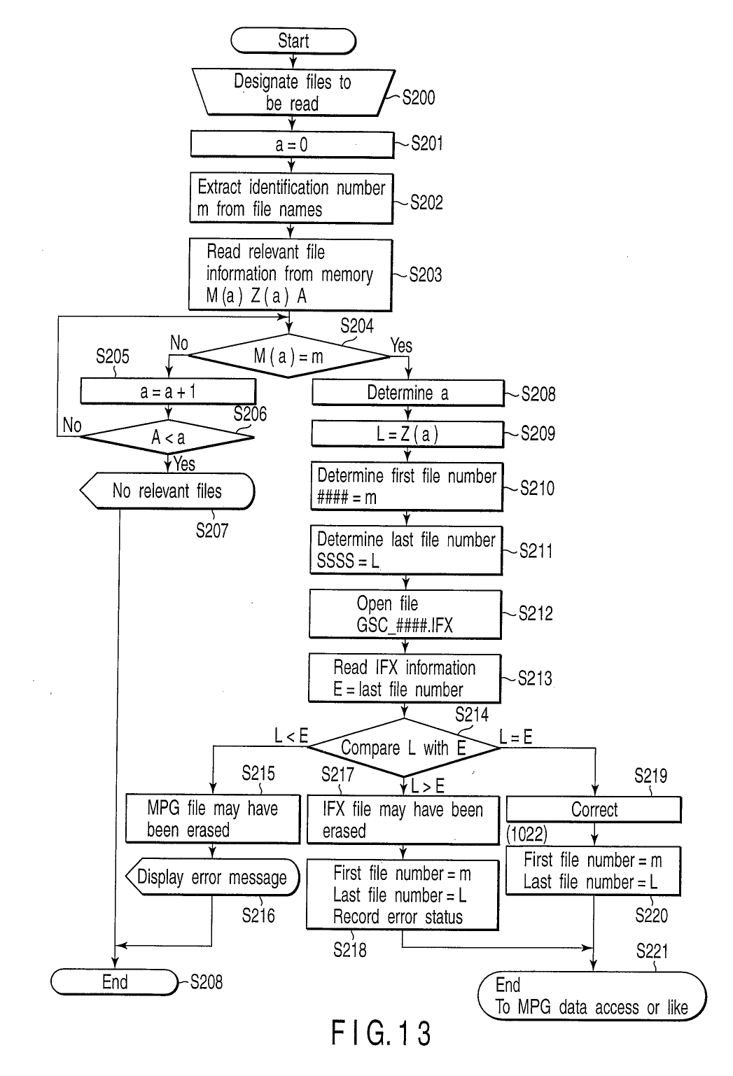

FIGS. 11 and 12 are flowcharts illustrating the processing (1) to (3) for searching moving image stream data files in the above cases illustrated in FIGS. 5 to 7.

When the image shooting apparatus is started, the CPU 114 searches for moving image information data files and moving image stream data files recorded on the HDD 105, and generates a database indicating correspondence between the files in the memory 104.

First, the CPU 114 searches for moving image information data files and moving image stream data files recorded on the HDD 105 according to file names (step S100).

The CPU 114 resets a holding variable to X=000h for parameter X to perform search according to the file name (step S101). The variable X holds the existence state of moving image stream data files and moving image information data files.

The CPU 114 sets parameters n and a for performing search according to file names to “n=0, and a=0” (step S102). The variable n is a counter, and is incremented one by one from 0001 to 9999. The variable a is an address number used when database is recorded on the memory 104.

The CPU 114 sets the variable n to n+1 (step S103), and searches for files in succession. In this processing, the CPU 114 determines whether the counter does not exceed 9999 (step S104). When the counter exceeds 9999 (YES in step S104), the CPU 114 ends search for moving image stream data files (step S105).

If the counter does not exceed 9999 (NO in step S104), the CPU 114 searches for moving image stream data files with a file name “GSC_####.MPG” and the identification number “####” equal to the value of the variable n (steps S106, S107). Since the value of the variable n starts from 1, first, the CPU 114 searches for a moving image stream data file with a file name “GSC_{—}0001.MPG”. When there is such a moving image stream data file, the CPU 114 performs an OR operation for the variable X with 001h (step S108). If there is no such moving image stream data file, the CPU 114 performs an OR operation for the variable X with 000h (step S109).

Next, the CPU 114 searches for a moving image information data file with a file name “GSC_####.IFX” and the identification number “####” equal to the variable n (step S110, step S111). Since the value of the variable n starts from 1, the CPU 114 searches for a moving image information data file with a file name “GSC_{—}0001.IFX”.

When there is such a moving image information data file, the CPU 114 performs an OR operation for the variable X with 010h (step S112). If there is no such moving image information data file, the CPU 114 performs an OR operation for the variable X with 000h (step S113).

Next, the CPU 114 searches for moving image information data files under different conditions according to the value of the variable X (step S114).

If the variable X is 000h (step S115), the CPU 114 determines that there are neither moving image stream files nor moving image information data files including the identification number “####=n” (step S116). Further, the CPU 114 sets the variable X to 000h (step S117) and sets variables m and L to 0 (step S118). Then, the CPU 114 returns to step S103, and searches for next files. The variable m indicates the identification number of the first moving image stream data file when one title is constituted by a plurality of moving image stream data files, and the variable L indicates the identification number of the last moving image stream data file. Specifically, in this search, no moving image stream data files and no moving image information data file are associated with respect to the identification number “####=n”.

If the variable X is 010h (step S119), the CPU 114 determines that there is only a moving image information data file including the identification number #### equal to the value of the variable n in its file name (step S120). Since such a state is impossible, the CPU 114 performs error processing (step S121). The CPU 114 displays an error message on the LCD 51, and erases the moving image information data file (step S122). Then, the CPU 114 sets the variable X to 000h (step S123), and sets the variables m and L to 0 (step S124). Then, the CPU 114 returns to step S103, and searches for next files. Specifically, also in this search, no moving image stream data files and moving image information data files are associated with respect to the identification number “####=n”.

If the X is 001h (step S125), the CPU 114 determines that there is only a moving image stream data file including the identification number #### equal to the value of n (step S126). It is generally impossible for only a moving image stream data file to exist in the state where the byte of the highest order of X is 0, and thus the CPU 114 performs error processing (step S127). The CPU 114 displays an error message on the LCD 51 that there is an inconvenient and impertinent moving image stream data file (step S128). Then, the CPU 114 sets the variable X to 000h (step S129), and sets the variables m and L to 0 (step S130). Thereafter, the CPU 114 returns to step S103, and searches for next files. Specifically, also in this search, no moving image stream data files and moving image information data files are associated with respect to the identification number “####=n”.

If the variable X is 011h (step S131), the CPU 114 determines that there are both a moving image stream data file and a moving image information data file including identification number #### equal to the value of n in their file names (step S132). In this case, the CPU 114 recognizes that there are a moving image stream data file corresponding to image information of one title and a moving image information data file thereof (step S133). Since there are cases where there are a plurality of moving image stream data files corresponding to the title, the CPU 114 stores the value of n as the variable m indicating the first moving image stream data file of divided moving images (step S134). Further, the CPU 114 stores the value of n as the variable L indicating the last moving image stream data file (step S135), and assigns 100h to the variable X (step S136). Then, the CPU 114 returns to step S103, and searches for next files.

If the variable X is 100h (step S137), the CPU 114 determines that there is both a moving image stream data file and a moving image information data file including the identification number put into the variable m in their file names, or there are neither moving image stream data file nor moving image information data file including identification number n in their file names in the state where divided moving images exist (step S138).

In this case, since a moving image stream data file including the identification number put into the variable m in its file name normally exists, the CPU 114 determines that the moving image stream data file including identification number n−1 in its file name and a moving image information data file including the identification number put into the variable m in its file name forms a pair for the same title (step S139).

Then, the CPU 114 records the value of the variable m as M(a), the value of the variable L as Z(a), and the value of the variable a (which corresponds to the number of titles recorded as image information) as A, in an area secured in the memory 104 (step S140).

The value M(a) indicates the identification number of the first moving image stream data file when the title corresponding to the address number a is formed of divided moving images. The value Z(a) indicates the identification number of the last moving image stream data file when the title corresponding to the address number a is formed of divided moving images. The value A indicates the number of image information items associated as one title.

Further, after recording the value of m as M(a), the value of L as Z(a), and the value of a as A in the memory 104, the CPU 114 increments the value of the variable a to a+1 (step S141), resets the variables m and L to 0 (step S142), and assigns 000h to the variable X (step S143), to search for moving image stream data files and a moving image information data file corresponding to image information of the next title. Then, the CPU 114 returns to step S103.

If the variable X is 110h (step S144), the CPU 114 determines that there are both a moving image stream data file and a moving image information data file with file names which include the identification number put into the variable m, or there is only a moving image information data file including the identification number n in its file name in the state where divided moving images exist (step S145).

In this case, since it is impossible for there to be only a moving image information data file including the identification number n in its file name without a moving image stream data file including the identification number n in its file name, the CPU 114 performs error processing (step S146). The CPU 114 displays an error message on the LCD 51, and erases the moving image information data file (step S147).

Then, the CPU 114 determines that a plurality of moving image stream data file from a moving image stream data file including the identification number m in its file name to a moving image stream data file including the identification number L in its file name and a moving image information data file including the identification number m in its file name correspond to image information of the same title (step S148).

Thereafter, since a moving image stream data file including the identification number put into the variable m in its file name normally exists, the CPU 114 records the value of the variable m as M(a), the value of the variable L as Z(a), and the value of the variable a as A, in an area in the memory 104 (step S149). After recording the value of the variable m as M(a), the value of the variable L as Z(a), and the value of the variable a as A in the memory 104, the CPU 114 increments the value of the variable a to a+1 (step S150), resets the variables m and L to 0 (step S151), and assigns 000h to X (step S152). Then, the CPU 114 returns to step S103.

If the variable X is 111h (step S153), the CPU 114 determines that there are both a moving image stream data file and a moving image information data file which have file names including the identification number put into the variable m, or there is both a moving image stream data file and a moving image information data file including the identification number n in their file names in the state where divided moving images exist (step S154). The CPU 114 determines that a plurality of moving image stream data file ranging from a moving image stream data file including the identification number m in its file name to a moving image stream data file including the identification number L in its file name and a moving image information data file including the identification number m in its file name correspond to image information of the same title (step S155). Further, since a moving image stream data file including the identification number put into the variable m in its file name normally exists, the CPU 114 records the value of the variable m as M(a), the value of the variable L as Z(a), and the value of the variable a as A, in an area in the memory 104 (step S156). After recording the value of the variable m as M(a), the value of the variable L as Z(a), and the value of the variable a as A in the memory 104, the CPU 114 increments the value of the variable a to a+1 (step S157), to search for a moving image stream data file and a moving image information data file for the next title. Since there is both a moving image stream data file and a moving image information data file including the identification number n in their file names, the CPU 114 recognizes that there are a moving image stream data file and a moving image information data file including the identification number n in their file names for the same title. Further, since there are cases where there are a plurality of moving image stream data files corresponding to the title, the CPU 114 stores the value of n as the variable m indicating the first moving image stream data of divided moving images (step S158). Further, the CPU 114 also stores the value of n as the variable L indicating the last moving image stream data file (step S169), and assigns 100h to the variable X (step S160). Then, the CPU 114 returns to step S103, and searches for next files.

If the variable X is 101h (step S161), the CPU 114 determines that there are both a moving image stream data file and a moving image information data file with file names including the identification number put into the variable m, or there is only a moving image stream data file including the identification number n in its file name in the state where divided moving images exist (step S162). Therefore, the CPU 114 determines that the moving image stream data file including the identification number n in its file name belongs to the same title as the moving image stream data file including the identification number m in its file name, and includes divided moving images following the divided moving images of the title (step S163). Specifically, the CPU 114 determines that the moving image stream data file including the identification number n in its file name belongs to the same title as the moving image stream data file including the identification number n−1 in its file name, and includes divided moving images following the divided moving images of the title. Since there are a plurality of moving image stream data files of the title, the CPU 114 stores the value of n as the variable L indicating the last moving image stream data file (step S164), and assigns 100h to the variable X (step S165). Then, the CPU 114 returns to step S103, and searches for next files.

In the flow explained with reference to FIGS. 11 and 12, the range of moving image stream data files of divided moving images for one title cannot be accurately determined, when a plurality of moving image stream data files are generated for one title in the case where X is 001h or in the file directory structure illustrated in FIG. 8.

Therefore, when image information recorded on the HDD 105 is played back or image information for one title is erased, moved or copied, the CPU 114 opens the moving image stream data files corresponding to the selected image information, and processes the files on the basis of the range information of moving image stream data files, which is included in the header of the moving image information data file of the title as illustrated in FIG. 9.

The cases where X is 001h, 010h or 110h do not occur in operation in the image shooting apparatus. Therefore, the CPU 114 can generally determine that they are errors by the operation illustrated in FIGS. 11 and 12. The following operation illustrated in FIG. 13 is processing performed when an error occurs.

FIG. 13 is a flowchart illustrating the processing of the above item (4) performed in a search for moving image stream data files in the case illustrated in FIG. 8.

First, when the CPU 114 recognizes that the user selects playback of image information recorded on the HDD 105 or erasure, shift or copying of image information for one title, the CPU 114 designates at least one moving image stream data file and a moving image information data file corresponding to the image information as objects to be read from the HDD 105 (step S200). Then, the CPU 114 extracts identification number m from file names of the moving image stream data file(s) and the moving image information data file to be read from the HDD 105 (step S202). Thereafter, the CPU 114 determines correct files to be read from among the moving image stream data file(s) and the moving image information data file corresponding to the image information, while comparing them with the values of M(a), Z(a) and A stored in the memory 104 (step S203).

The CPU 114 determines whether the identification number m matches the value of M(a) stored in the memory 104 (step S204). When the identification number m does not match the value of M(a) (NO in step S204), the CPU 114 increments the value of a (step S205), and determines whether the incremented value of a exceeds the maximum value A (step S206). When the value of a exceeds the maximum value A (YES in step S206), the CPU 114 determines that there are no moving image stream data files or moving image information data file to be read in the HDD 105 (step S207), and ends the processing (step S208). When the value of a does not exceeds the maximum value A (NO in step S206), the CPU 114 returns to step S204, reads the next value of M(a) stored in the memory 104, and compares the value with the identification number m.

When the value of M(a) matches the identification number m (YES in step S204), the CPU 114 determines the value of a (step S208). Then, the CPU 114 specifies the value of L (=Z(a)) on the basis of the determined value of a stored in the memory 104 (step S209).

Next, the CPU 114 determines that the first identification number of moving image data files corresponding to the selected image information is “####=m” (step S210), and determines that the last identification number is “$$$$=L” (step S211).

Thereafter, the CPU 114 reads a moving image information data file with the file name “GSC_$$$$.IFX” from the HDD 105, and opens the file (step S212). The CPU 114 reads the identification number E of the last moving image stream data file, from the range information specifying the range of the moving image stream data files which forms a pair with the moving image information data file as one title (step S213). The range information is recorded in the header of the moving image information data file “GSC_$$$$.IFX”. Then, the CPU 114 compares the value of L read from the memory 104 and determined in step S209 with the value of E recorded in the header of the moving image information data file (step S214).

When the value of L is smaller than the value of E, the CPU 114 determines that a moving image stream data file located at a midpoint or the end of the divided images may have been erased on purpose (step S215). This means that the selected image information cannot be normally played back. Therefore, the CPU 114 displays an error message on the LCD 51 (step S216), and ends the processing (step S208).

When the value of L is larger than the value of E, the CPU 114 determines that a moving image information data file may have been erased on purpose (step S217). Therefore, the CPU 114 determines that moving image stream data files including identification numbers larger than E are in an inconsistent state. Since moving image stream data files with identification numbers smaller than E and the identification number E normally exist, the CPU 114 designates m as the identification number of the first moving image stream data file of divided moving images for one title, designates L as the identification number of the last moving image stream data file, and records occurrence of an error in the memory 104 (step S218). Further, the CPU 114 performs processing such as playback of moving image stream data files corresponding to the selected image information (step S214).

When the value of L is equal to the value of E, the CPU 114 determines that correspondence between the moving image stream data files recorded in the memory 104 and the moving image information data file is correct (step S219). The CPU 114 designates m as the identification number of the first moving image stream data file of divided moving images for one title, and designates L as the identification number of the last moving image stream data file (step S220). Then, the CPU 114 performs processing such as playback of moving image stream data files corresponding to the selected image information (step S220).

As described above, when there are a plurality of moving image stream data files generated for one title, the CPU 114 can easily determine which moving image stream files forms one title, based on file names of moving image stream files and the file structure. This structure eliminates the need for accessing the moving image information data file each time to read information for determination, and thus contributes to increased efficiency in processing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image shooting apparatus comprising:
shooting means for shooting image information;
generating means for generating a moving image stream data file and a moving image information data file as separate files for one title in the image information shot by the shooting means, the moving image information data file being formed of information associated with the moving image stream data file; and
first recording means for recording the moving image stream data file and the moving image information data file generated by the generating means as separate files.

2. An image shooting apparatus according to claim 1, further comprising:
control means for associating the moving image stream data file with the moving image information data file recorded on the first recording means, based on a file name of the moving image stream data file and a file name of the moving image information data file; and
second recording means for recording information indicating correspondence between the moving image stream data file and the moving image information data file which are associated with each other by the control means.

3. An image shooting apparatus according to claim 2, wherein
the generating means generates at least one moving image stream data file for the title in the image information shot by the shooting means, and generates one moving image information data file corresponding to the moving image stream data file.

4. An image shooting apparatus according to claim 3, wherein
When two or more moving image stream data files are generated for the title of the image information, the generating means includes sequential identification numbers in file names of the moving image stream data files, and includes the smallest number in the sequential identification numbers, which are included in the file names of the moving image stream data files, in the file name of the moving image information data file.

5. An image shooting apparatus according to claim 4, wherein
the control means associates the moving image stream data files for the title with the moving image information data file corresponding to the moving image stream data files which are recorded on the first recording means.

6. An image shooting apparatus according to claim 5, wherein
when there is a moving image information data file including an identification number n in its file name and a moving image stream data file including the identification number n in its file name, and there is a moving image information data file including an identification number m larger than the identification number n in its file name and a moving image stream data file including the identification number m in its file name, the control means determines that the moving image stream data file including the identification number n in its file name to the moving image stream data file including an identification number which is smaller by one than the identification number m in its file name belong to one title.

7. An image information recording method comprising:
generating a moving image stream data file and a moving image information data file as separate files for one title in shot image information, the moving image information data file being formed of information associated with the moving image stream data file; and
recording the generated moving image stream data file and the moving image information data file as separate files.

8. An image information recording method according to claim 7, further comprising:
recording information indicating correspondence between the moving image stream data file and the moving image information data file which are associated with each other, based on a file name of the moving image stream data file and a file name of the moving image information data file.

9. An image information recording method according to claim 8, wherein:
at least one moving image stream data file is generated for the title in the image information, and one moving image information data file corresponding to the moving image stream data file is generated.

10. An image information recording method according to claim 9, wherein
when two or more moving image stream data files are generated for the title of the image information, sequential identification numbers are included in file names of the moving image stream data files, and the smallest number in the sequential identification numbers which are included in the file names of the moving image stream data files is included in the file name of the moving image information data file.

11. An image information recording method according to claim 10, wherein
the moving image stream data files for the title is associated with the moving image information data file corresponding to the moving image stream data files.

12. An image information recording method according to claim 11, wherein
when there is a moving image information data file including an identification number n in its file name and a moving image stream data file including the identification number n in its file name, and there is a moving image information data file including an identification number m larger than the identification number n in its file name and a moving image stream data file including the identification number m in its file name, it is determined that the moving image stream data file including the identification number n in its file name to the moving image stream data file including an identification number which is smaller by one than the identification number m in its file name belong to one title.
